(19) United States
(12) Patent Application Publication
(10) Pub. No.: US 2002/0132593 A1
(43) Pub. Date: Sep. 19, 2002

(54) System for providing a mobile telephone service on board a vehicle

(75) Inventors: Gerard Auvray, Bezons (FR); Jean Charpentier, Viroflay (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 10/000,362

(22) Filed: Dec. 4, 2001

(30) Foreign Application Priority Data
Mar. 15, 2001 (FR) 01 03 527

(51) Int. Cl. H04Q 7/20

(52) U.S. Cl. 455/99; 455/98; 455/427

(57) ABSTRACT

A system for providing a mobile telephone service on board a vehicle is connected to a public land mobile network via a satellite and can set up at least one transport connection between the vehicle and the public land mobile network before receiving a call request and then use the transport connection for a call as soon as a request to set up a call is received.

### CROSS-REFERENCE TO RELATED APPLICATIONS

This application is based on French Patent Application No. 01 03 527 filed Mar. 15, 2001, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to a system for providing a mobile telephone service on board a vehicle, and more precisely to a system which is connected to a terrestrial mobile telephone network via a satellite.

2. Description of the Prior Art

The conventional mobile telephone connection process used at present is shown in FIG. 2, which corresponds to the prior art and shows two mobile telephone equipment units A and B, one equipping a vehicle and the other used by the terrestrial network. When a user 1 in the vehicle, and therefore using the equipment unit A of the vehicle, requests setting up a call to a terrestrial user 2, the mobile telephone connection process is as follows:

Step 1: Requesting connection of the telephone of the passenger 1 to the equipment unit A;

Step 2: Requesting a connection between the equipment unit A and the equipment unit B;

Step 3: Setting up and activating the connection between the equipment units A and B; and

Step 4: Connecting the equipment unit B to the user 2.

The time to set up the connection between the equipment units A and B therefore delays setting up the mobile telephone connection between the two users 1 and 2.

The invention solves this problem.

### SUMMARY OF THE INVENTION

The invention provides a system for providing a mobile telephone service on board a vehicle, the system being connected to a public land mobile network via a satellite and including means for setting up at least one transport connection between the vehicle and the public land mobile network before receiving a call request and for then using the transport connection for a call as soon as a request to set up a call is received.

A connection between users is therefore obtained faster, the above step 2 and at least part of the above step 3 being eliminated for mobile telephone calls between users.

In a preferred embodiment, the transport connection is a connection in the standby state.

That connection in the standby state therefore does not consume any resources.

The duration of the transport connection is advantageously limited and reactivated in accordance with a time-delay.

The invention is described hereinafter in more detail with reference to drawings showing a preferred embodiment of the invention.

### BRIEF DESCRIPTION OF THE DRAWINGS

FIG. 1 is a diagrammatic view of mobile telephone call set-up between vehicles, here aircraft, and terrestrial equipment units.

FIG. 2, already discussed, is a diagram showing the steps of a prior art method of setting up a mobile telephone connection between two users, one in a vehicle provided with a connection equipment unit and the other using a terrestrial connection equipment unit.

FIG. 3 is a diagram showing the steps of a method in accordance with the invention of setting up a mobile telephone connection between two users, one in a vehicle provided with a connection equipment unit and the other using a terrestrial connection equipment unit.

### DETAILED DESCRIPTION OF THE PREFERRED EMBODIMENT

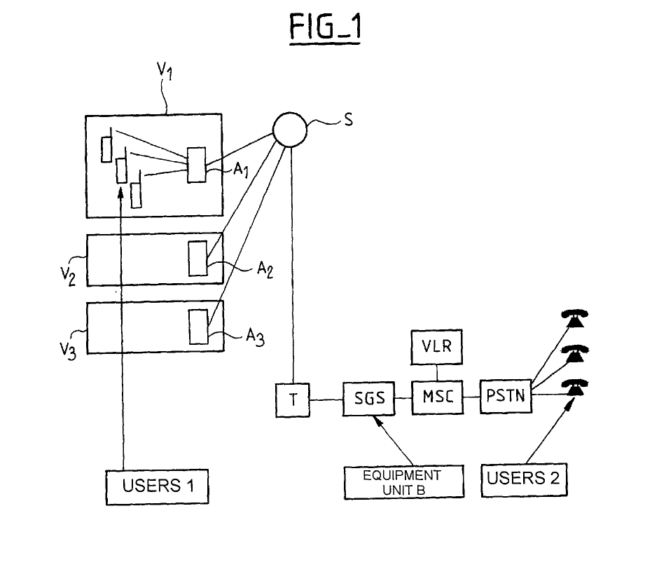

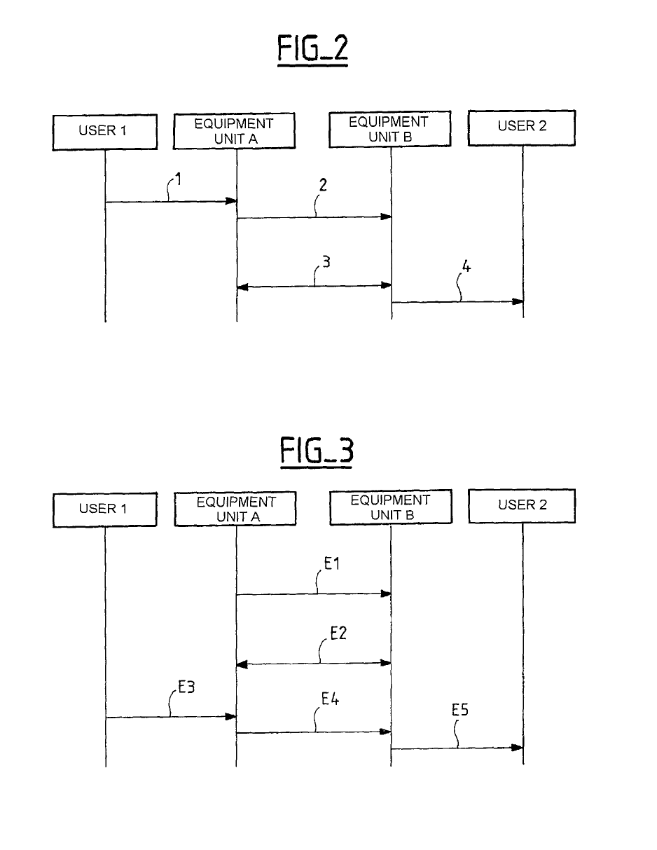

As shown in FIG. 1, a mobile telephone system conventionally includes a public land mobile network (PLMN) including a mobile switching center (MSC) connected to a visitor location register (VLR) and to the public switched telephone network (PSTN).

The MSC is also connected via a gateway SGS and a ground station T to a satellite S that sends radio signals to the connection equipment units Ai of the vehicles, for example the aircraft Vi.

The system according to the invention provides a mobile telephone service on board vehicles Vi that have no connection equipment units Ai; the system is connected to the public land mobile network via the satellite S.

In what follows, it is therefore understood that any mobile telephone connection including a user in a vehicle, for example an aircraft, is effected via the satellite S.

As shown in FIG. 3, the system according to the invention includes means for setting up at least one transport connection E2 between each vehicle, for example each aircraft, and the public land mobile network via the ground station T and the gateway SGS, before receiving any request to set up a call E3 and then using that transport connection E2 for a call as soon as a request to set up a call E3 is received.

To be more precise, considering two mobile telephone equipment units A and B, one equipping a vehicle and the other used by the terrestrial network, the following take place before a request to set up a call E3:

a request for a connection El between the two equipment units A and B, and

setting up a connection E2 between the two equipment units A and B.

In the preferred embodiment, the transport connection E2 remains in a standby state, i.e. in a state that does not consume resources, for example in the ringing phase.

If the user 1 sends a request for a connection E3, the resources of the transport connection are activated (step E4) and a connection E5 with the user 2 is set up, i.e. in a response signal state.

The duration of said transport connection E2 can be limited and reactivated in accordance with a time-delay.

There is claimed:

1. A system for providing a mobile telephone service on board a vehicle, said system being connected to a public land mobile network via a satellite and including means for setting up at least one transport connection between said vehicle and said public land mobile network before receiving a call request and for then using said transport connection for a call as soon as a request to set up a call is received.

2. The system claimed in claim 1 wherein said transport connection remains in a standby state.

3. The system claimed in claim 1 wherein the duration of said transport connection is limited and reactivated in accordance with a time-delay.

4. The system claimed in claim 1 wherein said vehicles are aircraft.
